(19) United States
(12) Patent Application Publication
(10) Pub. No.: US 2013/0277340 A1
(43) Pub. Date: Oct. 24, 2013

(54) Fiber Based Spectroscopic Imaging Guided Laser Material Processing System

(71) Applicants: Jian Liu, Sunnyvale, CA (US); Huan Huang, Fremont, CA (US)

(72) Inventors: Jian Liu, Sunnyvale, CA (US); Huan Huang, Fremont, CA (US)

(73) Assignee: POLARONYX, INC., San Jose, CA (US)

(21) Appl. No.: 13/454,044

(22) Filed: Apr. 23, 2012

(51) Int. Cl. B23K 26/00

(52) U.S. Cl. 219/121.61

(57) ABSTRACT

Methods and systems for fiber-based near-field material processing are disclosed, including generating electromagnetic radiation from a USP laser coupled to a central processing unit; coupling the electromagnetic radiation to an acousto-optic modulator; coupling the electromagnetic radiation to a beam delivery system; coupling the electromagnetic radiation to a beam delivery/collection fiber; using the electromagnetic radiation to generate a plasma on a target mounted to an adjustable stage coupled to the central processing unit; coupling the electromagnetic radiation from the plasma to the beam delivery/collection fiber; coupling the electromagnetic radiation to an optical fiber bundle; coupling the electromagnetic radiation to a spectrum analysis unit; coupling the electromagnetic radiation to a detector; and coupling the detector to the central processing unit; wherein the central processing unit uses the output from the detector as feedback in making adjustments to the USP laser and the adjustable stage. Other embodiments are described and claimed.

### BACKGROUND

The invention relates generally to the field of spectroscopic imaging guided micro/nano laser material processing systems. More particularly, the invention relates to a fiber based spectroscopic imaging guided material processing system for metals, semiconductor materials, glasses, ceramics, bio-tissues (hard tissues and soft tissues), and microorganisms.

### SUMMARY

In one respect, disclosed is a system comprising: a central processing unit; a USP laser; an acousto-optic modulator comprising an input and an output, wherein the USP laser is coupled to the input of the acousto-optic modulator; a beam delivery system comprising an input and an output wherein the output of the acousto-optic modulator is coupled to the input of the beam delivery system; a beam delivery/collection fiber comprising an input and an output, wherein the output of the beam delivery system is coupled to the input of the beam delivery/collection fiber and the output of the beam delivery/collection fiber is configured to emit a laser pulse; an adjustable stage coupled to the central processing unit and configured to allow positioning of a sample at the output of the beam delivery/collection fiber; an optical fiber bundle comprising an input and an output, wherein the input of the beam delivery/collection fiber is coupled to the input of the optical fiber bundle to allow coupling of a plasma electromagnetic radiation generated on the sample by the laser pulse; a spectrum analysis unit comprising an input and an output, wherein the output of the optical fiber bundle is coupled to the input of the spectrum analysis unit; and a detector comprising an input and an output, wherein the input of the detector is coupled to the output of the spectrum analysis unit and the output of the detector is coupled to the central processing unit.

In another respect, disclosed is a method for near-field material processing, the method comprising: generating electromagnetic radiation from a USP laser coupled to a central processing unit; coupling the electromagnetic radiation from the USP laser to an input of an acousto-optic modulator; coupling the electromagnetic radiation from an output of the acousto-optic modulator to an input of a beam delivery system; coupling the electromagnetic radiation from an output of the beam delivery system to an input of a beam delivery/collection fiber; using the electromagnetic radiation from an output of the beam delivery/collection fiber to generate a plasma on a target mounted to an adjustable stage coupled to the central processing unit; coupling the electromagnetic radiation from the plasma to the output of the beam delivery/collection fiber; coupling the electromagnetic radiation from the plasma from the input of the beam delivery/collection fiber to an input of an optical fiber bundle; coupling the electromagnetic radiation from an output of the optical fiber bundle to an input of a spectrum analysis unit; coupling the electromagnetic radiation from an output of the spectrum analysis unit to an input of a detector; and coupling an output of the detector to the central processing unit; wherein the central processing unit uses the output from the detector as feedback in making adjustments to the USP laser and the adjustable stage.

Numerous additional embodiments are also possible.

### BRIEF DESCRIPTION OF THE DRAWINGS

Other objects and advantages of the invention may become apparent upon reading the detailed description and upon reference to the accompanying drawings.

FIG. 1 is a schematic diagram of a fiber based spectroscopic imaging guided laser material processing system, in accordance with some embodiments.

FIG. 2 is a schematic illustration of the synchronization and control system design, in accordance with some embodiments.

FIG. 3 is an illustration of a tapered fiber end face for nanometer resolution, near-field enhancement generation, in accordance with some embodiments.

FIG. 4 is an illustration of different fiber end face shapes, in accordance with some embodiments.

FIG. 5 is a schematic illustration showing schematically the laser material processing across different material areas resulting in different plasma spectrum signal being collected via the same fiber with shaped end face, in accordance with some embodiments.

FIG. 6 is a block diagram illustrating a method of fiber based spectroscopic imaging guided laser material processing, in accordance with some embodiments.

FIG. 7 is a schematic illustration of a fiber based spectroscopic imaging guided laser material processing system, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

From microelectronics through bio-medical devices, there is a growing need for increased miniaturization, either to reduce the size of end products or to increase their functionality/size ratio. Present space-borne optical systems or communication systems typically rely on bulk optics, including mirrors and lenses rigidly mounted to an optical bench, to transfer the laser beam from optical sources to the exit aperture or from the entrance aperture to the objective. Such designs are typically sensitive to thermal and mechanical perturbations, and may substantially impact upon the host payload and real estate utilization. Optical fiber components and sensors have become increasingly more important for effectively transmitting and processing signals in many different optical fiber devices.

Lasers have been used to remove or otherwise manipulate materials in a variety of ways. Practical applications of laser processing commonly use pulsed laser, and more commonly use short pulsed laser. More recently, ultra-short pulsed (USP) lasers have been employed for laser processing or machining. The use of USP lasers has significantly improved the machining efficiency and precision. USP lasers are capable of quickly removing material due to their extremely high intensity energies which results in the instantaneous increase of the material temperature into a plasma regime. USP lasers are more effective in overcoming common thermal damage problems associated with traditional lasers. However, current laser processing techniques usually use bulk optics for the final beam delivering and focusing, including mirrors and lenses rigidly mounted to an optical bench or head. The system and method of the present invention is a fiber based laser material processing system with spectroscopic imaging guidance. Fiber based systems provide tightly focused spot size, resulting from the high beam quality of the fiber transmission, offer faster processing speeds with a larger working distance, and higher depth of focus. The latter two advantages can ease work piece tolerances. The higher optical efficiency of this system coupled with a more efficient use of wall-plug power reduces electricity costs. The extended mean-time between maintenance makes this system more attractive as well. Moreover, the compact head facilitates simple integration into motion systems, reducing the complexity of large tables. The lighter components can be moved at higher speed with fewer components and lighter structures, reducing motion power while still maintaining accuracy. The fiber based delivery eliminates the need for multi-mirror alignment procedures and, as the beam is contained in the fiber, the beam path is sealed to the processing point.

Laser-Induced Breakdown Spectroscopy (LIBS) is a type of atomic emission spectroscopy using highly energetic laser generated plasma to ablate and excite a solid, liquid, or gaseous sample. LIBS has been shown to be a powerful sensor technology in detecting and discriminating chemical hazards, biological hazards, explosive hazards, radionuclide hazardous materials both in close-contact and standoff modes. As a versatile method, LIBS has the primary advantages of versatile sampling, rapid analysis, little or no sample preparation, sensitive to a wide variety of elements, simultaneous analysis of multi-elements, and small amounts of material, and practically non-destructive. LIBS utilizes a focused high power laser onto a small area of the sample surface to vaporize and excite the sample in one step. In the LIBS technique, a pulsed laser beam is typically focused at a test point to produce a spark. The spark in the focal region, generates high density plasma with temperatures in excess of 10,000 K. At the high temperatures during the early plasma, the ablated material breaks all chemical bonds and dissociates into excited ionic and atomic species. During this time, the plasma emits a continuum of radiation which does not contain any specific wavelengths depending on the elements. As the plasma cools, the electron density of the plasma decreases and the continuum emission fades, such that each elemental emission line has a particular optimum in particular plasma and the characteristic emission are clear enough to detect elements. This optimum depends on the time/temperature history of the plasma, which in turn is dependent on the laser pulse energy and pulse length.

Most of the recent development of the LIBS system utilizes the traditional solid state nanosecond-range Nd:YAG laser. Unfortunately, the nanosecond laser source has certain less desirable features, such as broadband background emission, matrix effects which lead to undue pulse to pulse variation, and mixing of ambient air with the sample leading to compromised H, O, and N atom emissions (due to the approximately 10 microsecond microplasma lifetime). This latter limitation can be addressed through the use of the dual-pulse approach, but at a cost of system complexity and some increase in size and weight. Recently, more LIBS investigations using two optical fibers have been reported. One optical fiber for delivering the laser pulse to create sparks on the surface of the sample and another optical fiber for collecting emission signals from the spark.

When the laser pulse is on the order of nanoseconds, a significant amount of the later part of the energy pulse goes into heating the plasma formed during the earlier part of the pulse through linear absorption. The plasma formed is very highly ionized which results in large amounts of continuum emission, especially at short time scales. The air molecules also contribute to the broad emission background observed in the LIBS spectrum when nanosecond laser pulses are used to produce the breakdown. To avoid the difficulties of the broad emission background when using nanosecond pulsed lasers of the prior art, the broad continuum must be given time to decay before the desired spectra of the species for analysis are detected. This, however, has the disadvantage of limiting the use of the LIBS method when attempting to detect ion species at low concentrations and is an additional source of error in the measurement. Use of a gated detector to reduce background emission and thus, improve the signal to noise ratio and minimize spectral interferences between species may be used. Another disadvantage of LIBS processes with long pulsed nanosecond laser is the phenomenon of temperature dependent bleaching and large heat-affected zone as a result of linear absorption of the laser energy. With USP laser pulses, the plasma is induced from direct photoionization of the material through non-linear absorption, directly ionizing both conducting and wide band gap materials. USP laser pulses may also produce less thermal damage around the ablation region without melting effects and plasma reheating. Compared with conventional nanosecond pulsed lasers, significant advantages of LIBS using femtosecond laser pulses have been shown including high precision of sample ablation, reduced thermal damage, faster plasma dissipation, making possible the use of a non-gated detector, and lower threshold fluences. Moreover, the relatively low and rapid decrease of the background continuum excited by the femtosecond pulses make it possible to obtain fast and high throughput acquisition of LIBS atomic-line spectra with non-gated detectors and high laser pulse rates (at least ten times higher).

The methods of the invention described herein take advantage of the unique effects of USP lasers. When USP laser pulses are tightly focused onto the surface of materials, the high intensity inside the focal volume due to the tight focusing of the short laser pulse will induce multi-photon or tunneling ionization and subsequent avalanche ionization occurs. This nonlinear absorption results in the creation of hot plasma and subsequent heating to the surrounding materials. Because the ultra-short laser pulses of the present invention have lower energies than nanosecond pulses, less damage to surrounding materials and less ablation of material being analyzed by the laser spark occurs. Furthermore, less energy is transmitted to the air and surrounding materials. However, since nanosecond laser pulses are not conducive to submicron spatial resolution owing to the imparted thermal diffusion length, use of USP laser is beneficial for improving spatial resolution and providing sufficient momentum for collision dominated breakdown process, and therefore improved LIBS signal to background emission ratio. Therefore, USP lasers provide a LIBS process with an improved sensitivity, signal to background emission ratio, and spatial resolution.

The embodiment or embodiments described herein may solve these shortcomings as well as others by proposing a novel near-field assisted plasma spectrum material processing system with real time feedback and control. The laser material processing system utilizes a USP laser with near-field enhancement to achieve nanometer resolution. Feedback is provided during laser ablation or processing and is used to control the process parameters.

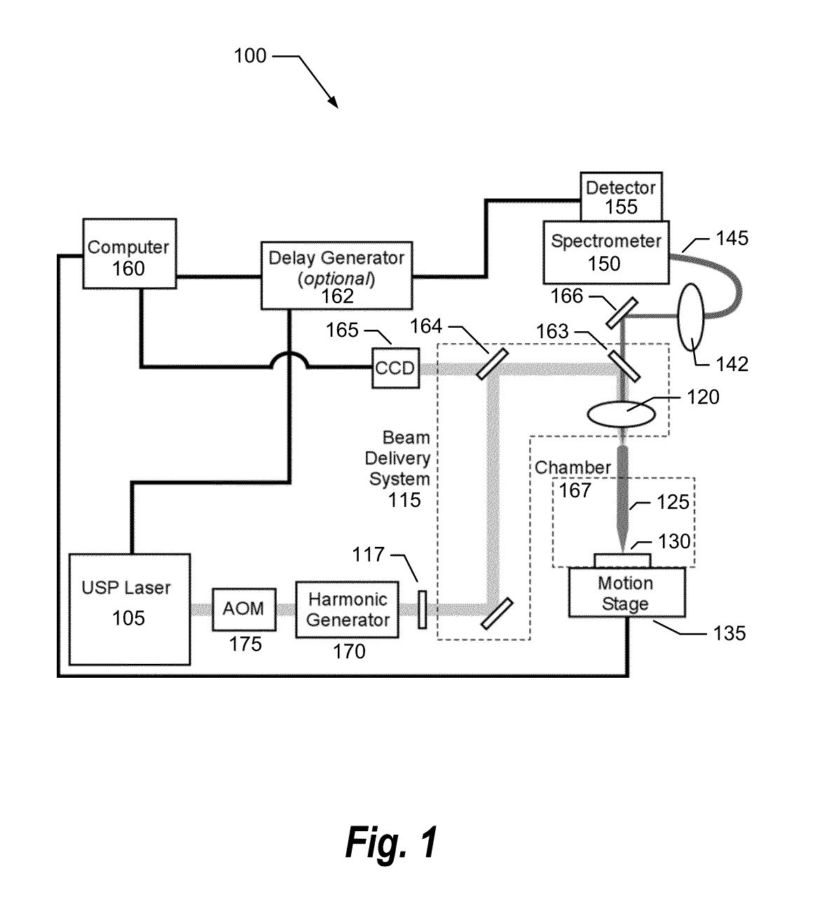

FIG. 1 is a schematic diagram of a fiber based spectroscopic imaging guided laser material processing system, in accordance with some embodiments.

In some embodiments, the fiber based spectroscopic imaging guided laser material processing system 100 comprises a USP laser source 105 configured to provide laser pulses for the system. Next, an acousto-optic modulator 175 is used to adjust the repetition rate of the output laser pulses. The laser output from the acousto-optic modulator 175 is coupled to a beam delivery system 115. An attenuator 117 may be used to attenuate the laser pulses prior to coupling into the beam delivery system 115. One or more mirrors of the beam delivery system 115 may comprise dichroic mirrors. The beam delivery system 115, delivers the collimated laser output to a coupler 120 such as an objective lens where the laser output is coupled to a beam delivery/collection fiber 125. The laser pulses from the beam delivery/collection fiber 125 create plasma on the surface of the sample. The plasma comprises excited ionic, atomic, and molecular species of the ablated surface of the sample. The electromagnetic information from the plasma plume is also collected by the beam delivery/collection fiber 125.

The beam delivery/collection fiber 125 is designed to focus the laser pulses onto the sample material to produce plasma and to simultaneously collect the plasma spectrum. In order to accomplish this delivery and collection, the beam delivery/collection fiber comprises double-clad fiber (DCF) or double-clad photonic-crystal fiber (DC PCF), usually with large numerical aperture between 0.4-0.8. The beam delivery/collection fiber may have a core size from 100 nm to 100 μm. The laser pulses are delivered by the core of the fiber and the LIBS signal is collected by the cladding and core of the fiber. Additionally, the beam delivery/collection fiber may comprise specific shaped end faces to provide focusing and nanometer resolution for material processing and to help spectroscopic emission collection. The end faces may be flat, rectangular, triangular, circular, semi-circular, elliptical, semi-elliptical or other shapes. The end faces may be fabricated by chemical etching, thermal pulling, laser micro-machining, etc., and may range in size from tens of nanometers to a few micrometers.

A sample fixture 130 secures the sample to be processed at the output end of the beam delivery/collection fiber 125. The sample fixture 130 is mounted to a multi-axis motion stage 135 to allow for accurate positioning of the sample. In this embodiment the multi-axis motion stage is capable of being adjusted in the X, Y, and Z axis. Other stages with additional adjustability in theta (rotation about the X or Y-axis) and phi (rotation about the Z-axis) are possible for adjustability in five axis of motion.

After the electromagnetic information from the plasma plume is collected by the beam delivery/collection fiber 125, the electromagnetic information is passed through a dichroic mirror 163 of the beam delivery system 115 and coupled with a coupler 142 to an optical fiber bundle 145. A filter 166 may be used to filter the wavelength of the probe laser beam. The opposite end of the optical fiber bundle 145 is coupled to a spectrum analysis unit such a spectrometer 150 where a grating within the spectrometer 150 disperses the electromagnetic information from the plasma plume. The spectrometer 150 can be a monochromator, a spectrograph, or a polychromator. The spectral range of the spectrometer 150 may be chosen to suit different applications. In some embodiments, the spectral range can be a few tens of nm for observing a specific portion of the wavelength range. Alternatively, the spectral range can be from UV to NIR. A detector 155 is used to detect the grating dispersed electromagnetic information and to feed this information to a central processing unit or computer 160. The detector 155 provides increased resolution and greater selectivity of the spectral information. The detector 155 may optionally comprise a suitable CCD, a suitable photomultiplier, an intensified charge-coupled device (ICCD), or a micro-channel image intensifier plate. The intensifier plate is preferably gated during a period of time when the plume emits characteristic optical emission. This period coincides with an optimum plume luminance period. This period follows emission of continuum radiation. Continuum radiation lacks useful specific species or elemental information. In one embodiment, a delay generator 162 may be included to provide gating of the detector to allow temporal resolution of the detector response time. The computer 160 may include a control system for providing synchronization of the USP laser source 105, the detector 155, and the multi-axis motion stage 135. The computer 160 may include a display for displaying spectral information and motion stage position information as well as application software and database information with known sample materials processing standard spectrum for different processing conditions in order to achieve real time analysis of the elemental composition of the sample.

In some embodiments, a dichroic mirror 164 of the beam delivery system 115 allows the viewing of the target or sample via a CCD camera 165 or other optical imaging device. The camera 165 may be used ahead of or behind the pulse to sense the location of the prospective machining path or to check the machining quality. Connecting the camera 165 to the computer 160 provides another feedback for the total overall control of the material processing system. The material processing system may include a system frame for housing all the various components described herein. The system frame may include an air filtered chamber 167 capable of removing the debris and contaminants produced during the material processing.

In some embodiments, a harmonic generator 170 may be utilized to extend the wavelengths at which the sample is processed and analyzed with. The different probe wavelengths may lead to different LIBS signals, thus expanding the utility of the material processing system by being able to change the spot size, focus position, wavelength, pulse energy, pulse width and/or repetition rate quickly as the laser ablation switches from material to material and layer to layer. Such a laser system would be well suited for the characterization of a wide variety of materials based upon the spectroscopic analysis of light generated during material ablation. In particular, spectroscopic data could be used to indicate that a particular layer had been removed and to prevent further ablation. For example, in an application requiring ablation of integrated components composed of a variety of materials, this invention allows for the combination of two or more harmonics (e.g., 515 nanometers and 258 nanometers).

The term “ultra-short pulse laser” or “USP laser” refers to a laser beam generated in the form of extremely brief and finite intervals, i.e., pulses. USP lasers used herein are characterized by various parameters. For instance, “pulse duration” refers to the length of time of each interval wherein the laser beam is generated. A suitable pulse duration may be, e.g., between about 1 fs to about 50 ps, preferably between about 100 fs to about 10 ps. The parameter “pulse energy” refers to the amount of energy concentrated in each interval wherein the laser beam is generated. Pulse energy may be between about 0.001 μJ to about 100 mJ, more preferably between about 0.1 μl to about 1 mJ. The single pulse fluence refers to the pulse energy delivered over the focal spot size. It may be between 0.001 J/cm² to 100 J/cm², preferably between about 0.1 J/cm² to about 10 J/cm². The parameter “repetition rate” refers to the number of pulses that are emitted per second, and indirectly relates to the time between each pulse emission, i.e., the length of time between each pulse. The repetition rate may be between about 1 kHz and about 100 MHz, preferably between about 100 kHz and about 10 MHz. The USP laser beam of the invention may be of any wavelength in the electromagnetic spectrum from deep UV to IR range. The wavelength may be between about 100 nm to about 10 μm, more preferably between about 100 nm to about 5 μm. The “focus spot size” refers to the diameter of the USP laser beam. This diameter may be, for example, between about 400 nm and about 100 μm, preferably between about 2 μm and about 20 μm.

The material processing system of FIG. 1 may be applied in material processing, including fabrication of micro-electro-mechanical systems (MEMS). Fabrication of MEMS demands comparable processing of various layers and structures made of different materials, including metals, ceramic, plastics, semiconductors, glasses, tissues (soft and hard), etc. Many devices are made of layered thin film structures with a plurality of interconnected functional layers that are conductive, semi conductive, insulating, doped, or protective. In particular, the ultra-short pulse duration and near-field enhanced intensity makes it possible to produce extremely high target intensities with relatively low pulse energy. The high target intensities, in conjunction with ultra-short pulse duration, enable precise micron/nano-level materials processing with minimal and/or manageable heat transfer to the target substrate per pulse.

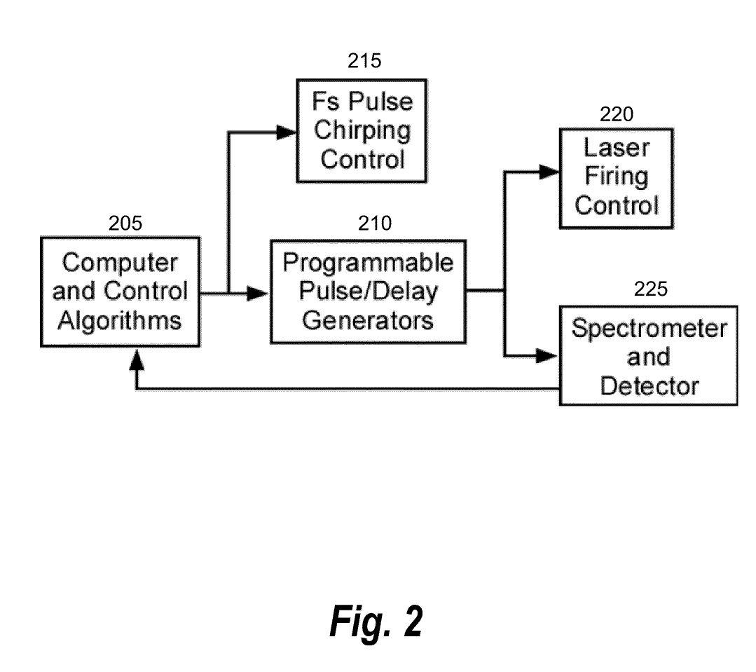

FIG. 2 is a schematic illustration of the synchronization and control system design, in accordance with some embodiments.

In some embodiments, the synchronization and control system will be coordinated by the system processor computer 205 through a delay/pulse generator 210 and associated electronics. The delay/pulse generator has a resolution of 5 ps and four output channels which are used to control the pulse firing time and sequence 215 of the USP laser 220, as well as the gate time of the detector and the spectrometer integration time 225. The delay is optional based on the requirement of the spectrum signal level and the signal-to-noise ratio.

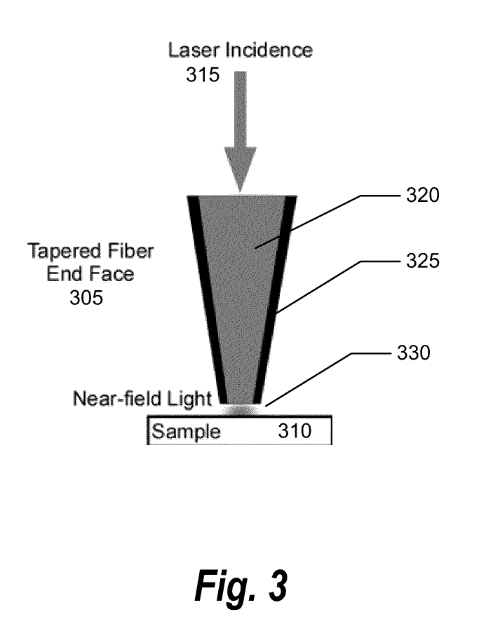

FIG. 3 is an illustration of a tapered fiber end face for nanometer resolution, near-field enhancement generation, in accordance with some embodiments.

In some embodiments, the fiber based spectroscopic imaging guided laser material processing system uses either a tapered fiber end face for delivering the laser to create sparks on the surface of the sample and the same optical fiber for collecting emission signals from the spark. A tapered fiber end face is pumped by the USP fiber laser, thus creating a compact source/probe. The fabricated source/probe is coated on the fiber surface to confine the scattering at the tip. The tip or aperture of the probe is in the nanometer range. Using a fine scanning platform, the fiber probe and the sample are brought together within a controlled distance using feedback based on response. To process the material, the sample is raster scanned with the probe held stationary in its lateral position. FIG. 3 shows a tapered fiber end face 305 within nanometer range of the sample 310. The laser pulses 315 from the USP fiber laser are guided through the tapered fiber end face 305. The tapered fiber end face 305 comprises a tapered fiber 320 with a metal coating 325 to confine the scattering at the tip of the tapered fiber end face 305. The laser pulses 315 hitting the surface of the sample create a plasma 330 that can be analyzed by the spectrometer of the system.

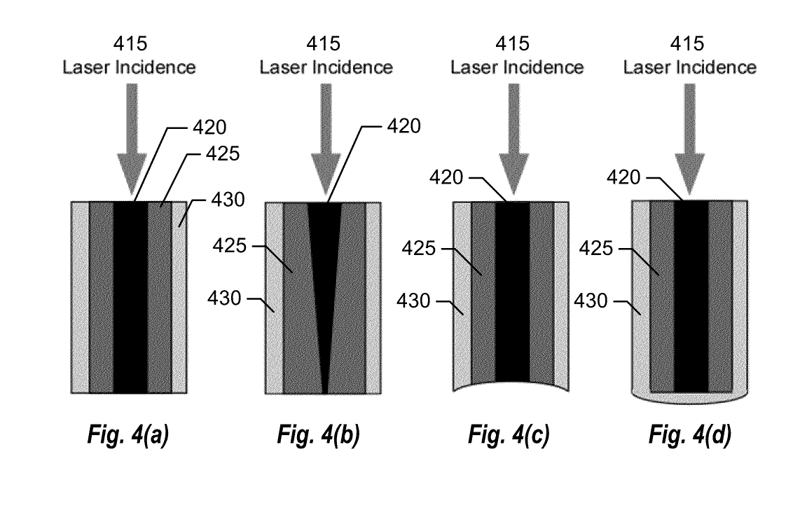

FIG. 4 is an illustration of different fiber end face shapes, in accordance with some embodiments.

In some embodiments, the beam delivery/collection fiber comprises shaped end faces to provide focusing and nanometer resolution for material processing and to help spectroscopic emission collection. The end face may be rectangular, triangular, semi-circular, semi-elliptical, or other shape. FIG. 4 illustrates several such end faces. The laser pulses 415 from the USP fiber laser are guided in the core 420 of the beam delivery/collection fiber. The beam delivery/collection fiber comprises the core 420 surrounded by an inner cladding 425 and an outer cladding 430. The core 420 may be tapered as illustrated in FIG. 4 (b). The end face of the beam delivery/collection fiber may be rectangular FIG. 4 (a) and FIG. 4 (b) or semi-elliptical FIG. 4 (c) and FIG. 4 (d). Other end face shapes are possible.

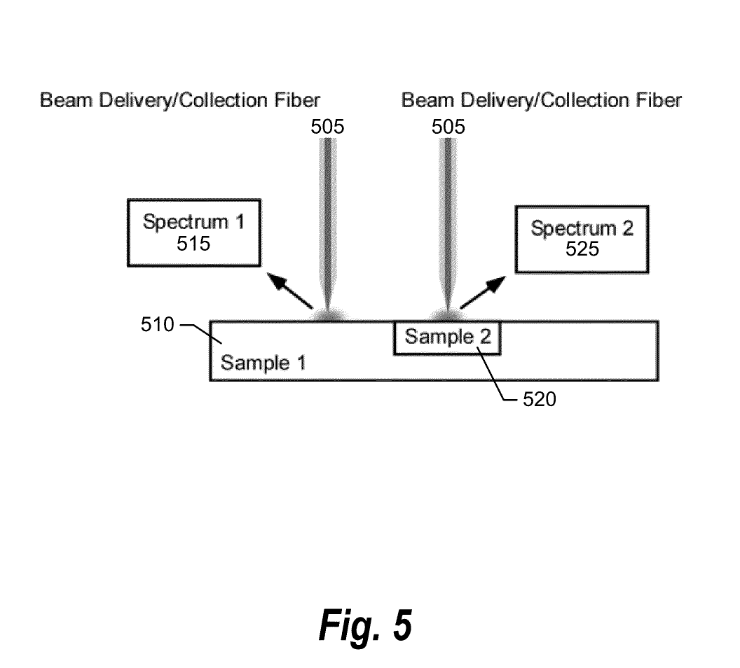

FIG. 5 is a schematic illustration showing schematically the laser material processing across different material areas resulting in different plasma spectrum signal being collected via the same fiber with shaped end face, in accordance with some embodiments.

In some embodiments, the fiber based spectroscopic imaging guided laser material processing system may be used on a structure that comprises two or more different materials. When the laser pulses delivered through the beam delivery/collection fiber 505 hit the structure comprised of sample 1 (510), a plasma with the primary chemical elements of the ablated material of sample 1 (510) will be created. The plasma results in a plasma spectrum signal 515 of sample 1 (510). Eventually the laser pulses delivered through the beam delivery/collection fiber 505 will be scanned to sample 2 (520) of the structure resulting in a plasma with the primary chemical elements of the ablated material of the sample 2 (520). The plasma results in a plasma spectrum signal of sample 2 (525) and by analyzing the differences in the spectrum signal, the laser processing parameters may be adjusted based on the material type. The system is capable of determining when there is a material change in the structure.

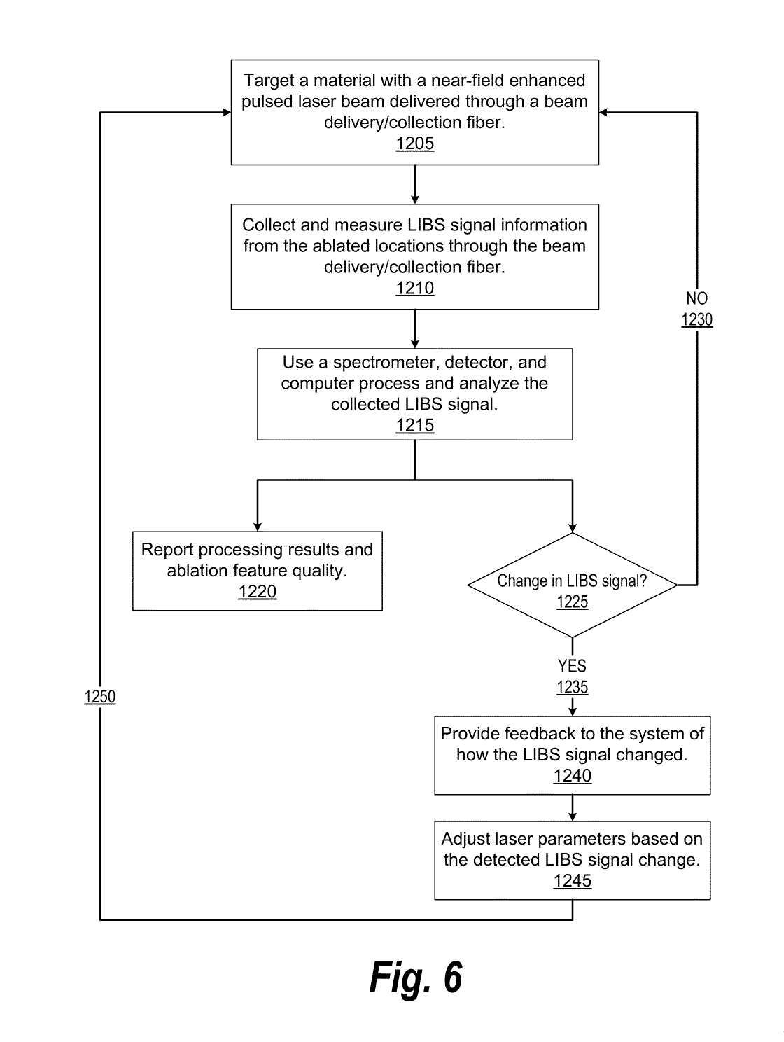

FIG. 6 is a block diagram illustrating a method of fiber based spectroscopic imaging guided laser material processing, in accordance with some embodiments.

In some embodiments, a USP fiber laser and a beam delivery/collection fiber are used to target a material with a near-field enhanced pulsed laser beam 1205. The near-field enhanced pulsed laser beam creates a plume of plasma. The LIBS signal information from the ablated locations is collected and measured by the beam delivery/collection fiber 1210. The collected signal then undergoes spectrum processing, analysis, and diagnostics using a spectrometer, detector, and computer 1215. The processing results and ablation feature quality may be reported 1220. A determination is then made to see if there was any change in the LIBS signal 1225. If a change was not detected 1230, processing returns to step 1205 with the same laser parameters, repeating the ablation, collection, measurement, and analysis. If a change was detected 1235, feedback is provided to the system of how the LIBS signal changed 1240 in order to adjust the laser parameters based on the detected LIBS signal change 1245. Processing then continues 1250 back to step 1205 with the adjusted laser parameters. For example, in some embodiments, when the feedback shows that there is an appearance of one chemical element and disappearance of another element, system control determines that the ablated material is changed and so instructs the laser to change the processing parameters (pulse energy, repetition rate and speed) optimized to that specific material. In some embodiments, the feedback shows that the relative count numbers of the spectrum spikes are decreasing. The system computer then instructs the laser to increase the pulse energy before repeating the ablation, collection, measurement, and analysis. Accordingly, a technique of end-point detection can be implemented in this way.

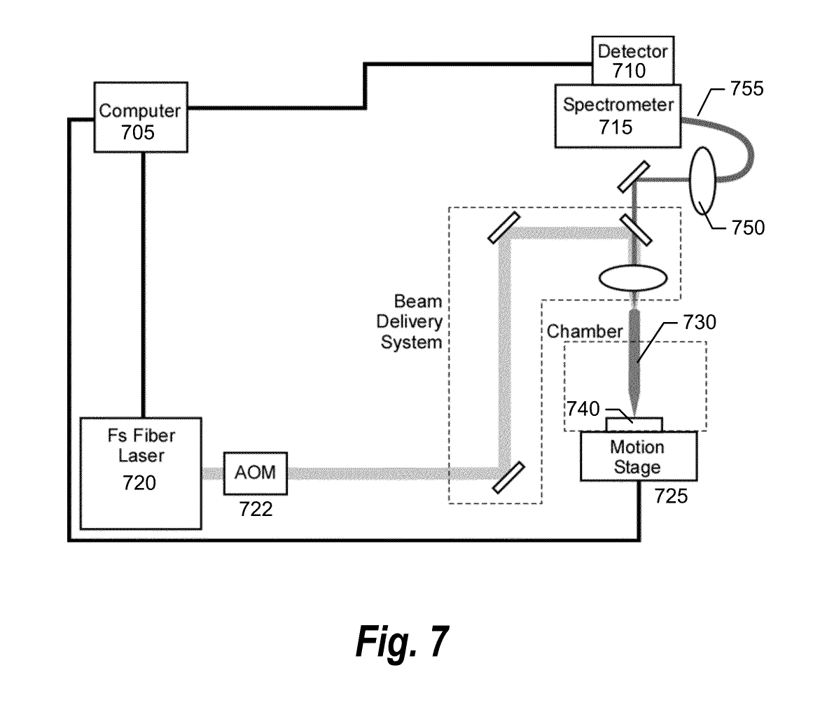

FIG. 7 is a schematic illustration of a fiber based spectroscopic imaging guided laser material processing system, in accordance with some embodiments.

In some embodiments, expensive components such as ICCDs and delay generators are not needed. FIG. 7 shows such a system having a computer 705 interconnected with a detector 710, a spectrometer 715, a fs fiber laser 720, an AOM 722, and a motion stage 725. Femtosecond laser pulses are delivered by the beam delivery/collection fiber 730 to create a plasma on the surface of the sample 740. The plasma plume is collected by the beam delivery/collection fiber 730. The beam delivery/collection fiber 730 couples, with a coupler 750, the electromagnetic information from the plasma plume into an optical fiber bundle 755. The other end of the optical fiber bundle is coupled to the spectrometer 715.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A system comprising:
a central processing unit;
a USP laser;
an acousto-optic modulator comprising an input and an output, wherein the USP laser is coupled to the input of the acousto-optic modulator;
a beam delivery system comprising an input and an output wherein the output of the acousto-optic modulator is coupled to the input of the beam delivery system;
a beam delivery/collection fiber comprising an input and an output, wherein the output of the beam delivery system is coupled to the input of the beam delivery/collection fiber and the output of the beam delivery/collection fiber is configured to emit a laser pulse;
an adjustable stage coupled to the central processing unit and configured to allow positioning of a sample at the output of the beam delivery/collection fiber;
an optical fiber bundle comprising an input and an output, wherein the input of the beam delivery/collection fiber is coupled to the input of the optical fiber bundle to allow coupling of a plasma electromagnetic radiation generated on the sample by the laser pulse;
a spectrum analysis unit comprising an input and an output, wherein the output of the optical fiber bundle is coupled to the input of the spectrum analysis unit; and
a detector comprising an input and an output, wherein the input of the detector is coupled to the output of the spectrum analysis unit and the output of the detector is coupled to the central processing unit.

2. The system of claim 1, further comprising a delay generator coupled between the central processing unit and both the detector and the USP laser.

3. The system of claim 1, further comprising a camera optically coupled to the beam delivery system and configured to view the sample.

4. The system of claim 1, further comprising a harmonic generator coupled between the acousto-optic modulator and the beam delivery system.

5. The system of claim 1, wherein the beam delivery/collection fiber comprises double-clad fiber or double-clad photonic-crystal fiber.

6. The system of claim 5, wherein the beam delivery/collection fiber has a numerical aperture ranging from about 0.4 to about 0.8.

7. The system of claim 5, wherein the beam delivery/collection fiber has a core size ranging from about 100 nm to about 100 μm

8. The system of claim 1, wherein the beam delivery/collection fiber comprises an end face comprising at least one of: a flat shape, a rectangular shape, a triangular shape, a circular shape, a semi-circular shape, an elliptical shape, and a semi-elliptical shape.

9. The system of claim 1, wherein the laser pulse has a pulse duration ranging from about 1 fs to about 50 ps.

10. The system of claim 1, wherein the laser pulse has a pulse energy ranging from about 0.001 μJ to about 100 mJ.

11. The system of claim 1, wherein the laser pulse has a single pulse fluence ranging from about 0.001 J/cm² to about 100 J/cm².

12. The system of claim 1, wherein the laser pulse has a pulse repetition rate ranging from about 1 kHz to about 100 MHz.

13. A method for near-field material processing, the method comprising:
generating electromagnetic radiation from a USP laser coupled to a central processing unit;
coupling the electromagnetic radiation from the USP laser to an input of an acousto-optic modulator;
coupling the electromagnetic radiation from an output of the acousto-optic modulator to an input of a beam delivery system;
coupling the electromagnetic radiation from an output of the beam delivery system to an input of a beam delivery/collection fiber;
using the electromagnetic radiation from an output of the beam delivery/collection fiber to generate a plasma on a target mounted to an adjustable stage coupled to the central processing unit;
coupling the electromagnetic radiation from the plasma to the output of the beam delivery/collection fiber;
coupling the electromagnetic radiation from the plasma from the input of the beam delivery/collection fiber to an input of an optical fiber bundle;
coupling the electromagnetic radiation from an output of the optical fiber bundle to an input of a spectrum analysis unit;
coupling the electromagnetic radiation from an output of the spectrum analysis unit to an input of a detector; and
coupling an output of the detector to the central processing unit;
wherein the central processing unit uses the output from the detector as feedback in making adjustments to the USP laser and the adjustable stage.

14. The method of claim 13, wherein a delay generator is coupled between the central processing unit and both the detector and the USP laser.

15. The method of claim 13, wherein a camera optically is coupled to the beam delivery system and configured to view the target.

16. The method of claim 13, wherein a harmonic generator is coupled between the acousto-optic modulator and the beam delivery system.

17. The method of claim 13, wherein the beam delivery/collection fiber comprises double-clad fiber or double-clad photonic-crystal fiber.

18. The method of claim 17, wherein the beam delivery/collection fiber has a numerical aperture ranging from about 0.4 to about 0.8.

19. The method of claim 17, wherein the beam delivery/collection fiber has a core size ranging from about 100 nm to about 100 μm

20. The method of claim 13, wherein the beam delivery/collection fiber comprises an end face comprising at least one of: a flat shape, a rectangular shape, a triangular shape, a circular shape, a semi-circular shape, an elliptical shape, and a semi-elliptical shape.

21. The method of claim 13, wherein the laser pulse has a pulse duration ranging from about 1 fs to about 50 ps.

22. The method of claim 13, wherein the laser pulse has a pulse energy ranging from about 0.001 μJ to about 100 mJ.

23. The method of claim 13, wherein the laser pulse has a single pulse fluence ranging from about 0.001 J/cm² to about 100 J/cm².

24. The method of claim 13, wherein the laser pulse has a pulse repetition rate ranging from about 1 kHz to about 100 MHz.
